(19) United States
(12) Patent Application Publication
(10) Pub. No.: US 2007/0153518 A1
(43) Pub. Date: Jul. 5, 2007

(54) LED bulb

(76) Inventor: Chi Gon Chen, Gueng Zhou (CN)

Correspondence Address: David G. Moore;Strasburger & Price, LLP, Suite 4400, 901 Main St., Dallas, TX, 75202, US

(21) Appl. No.: 11/394,897

(22) Filed: Jun. 1, 2006

Related U.S. Application Data
(60) Provisional application No. 60/754,407, filed on Dec. 28, 2005.

(51) Int. Cl. F21S 13/14

(52) U.S. Cl. 362/252

(57) ABSTRACT

An LED bulb includes a hollow enclosure and a lower cover assembly. The lower cover assembly includes a circuit which permits the connecting pins to be inserted into a two hole socket in either direction. The LEDs are mounted to expose their leads to ambient air to assist in cooling. The hollow enclosure includes reflective surfaces therein and a top reflector which also may include a reflecting surface therein.

### UNITED STATES UTILITY PATENT APPLICATION

1. This utility patent application claims priority to Provisional Patent 60/754407 filed Dec. 28, 2006 and Provisional Patent filed Mar. 22, 2006.

2. This invention was not supported by federally sponsored research or development.

### FIELD

The present invention pertains light bulbs; more particularly, the present invention pertains to light bulbs where LEDs are used as a source of light.

### BACKGROUND

In the past several years, there has been an explosion in the use of LEDs in a variety of applications. Initially, LEDs were small and did not provide a significant degree of illumination. Accordingly, LEDs were often used as indicator lights and not as a source of illumination. However, as the technology surrounding the construction and use of LEDs has progressed, LEDs are now being used in many illumination applications where incandescent lamps were once previously used. However, since the amount of light produced by LEDs is still small in comparison to many incandescent lamps, there remains a need in the art to maximize the illumination provided by one or more LEDs and to place the LEDs in a package similar to an incandescent light for user convenience.

### SUMMARY

The LED bulb of the present invention maximizes the illumination produced by a set of LEDs and places the LEDs in a package which is easily handled and replaced as needed for user convenience. In addition, the LEDs are wired so that the prongs or terminal pin connectors located on the base of the LED bulb of the present invention may be placed in a socket in either direction. To prolong the life of the LEDs within the LED bulb, the mounting of the LEDs within the LED bulb promotes cooling of the LEDs. Maximization of illumination is accomplished by the use of multiple reflective surfaces within the LED bulb to disperse the light rays emitted by the LEDs within the LED bulb enclosure.

### BRIEF DESCRIPTION OF THE DRAWING FIGURES

A better understanding of the LED bulb of the present invention may be had from the attached drawing figures, wherein:

FIG. 1 is a schematic drawing of a garden light set using the LED bulb of the present invention;

FIG. 2A is an elevational view of the LED bulb in partial section;

FIG. 2B is an exploded perspective view of the LED bulb shown in FIG. 2A with the LEDs removed;

FIG. 3A is an exploded perspective view similar to FIG. 2B showing an LED bulb with four LEDs;

FIG. 3B is an exploded perspective view similar to FIG. 2B showing an LED bulb with six LEDs; and

FIG. 4 is a circuit diagram of the internal circuitry within the LED bulb which allows the pins on the bottom of the LED bulb to be placed in either opening in a socket having two openings.

### DESCRIPTION OF THE EMBODIMENTS

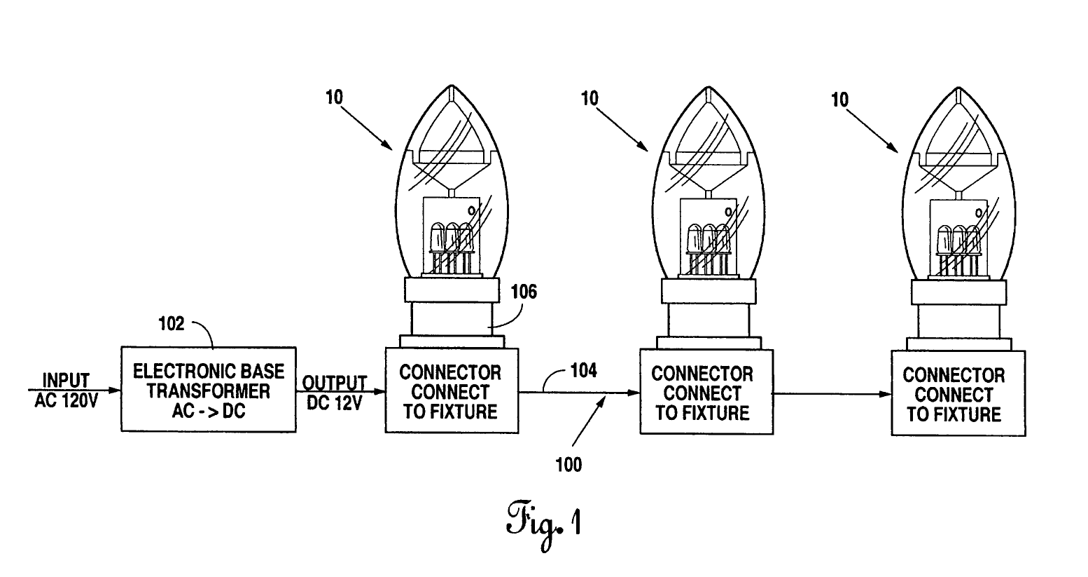

While there are many applications for the LED bulb 10 of the present invention, FIG. 1 illustrates the use of the LED bulb 10 of the present invention in garden lights 100. At the left side of FIG. 1 is a source of electrical power; typically 120 v AC house current. Because LEDs use low voltage direct current, the 120 v AC house current passes through a transformer 102 which converts the 120 v AC house current to 12 v DC. The 12 v DC passes through an electrical conductor or wires 104 to a plurality of sockets 106, each of which has two openings sized to accommodate the pin connectors on the bottom of an LED bulb 10. Thus, the LED bulbs 10 are removable from the sockets 106 for replacement as needed. In addition, if the user of a set of garden lights 100 wants to use LED bulbs 10 of different colors, all that is necessary is to remove an LED bulb 10 from the socket 106 and replace it with an LED bulb having the desired color.

As may be seen in FIGS. 1, 2A, 2B, 3A, and 3B, in the preferred embodiment of the LED bulb 10, a bullet or flame shaped enclosure assembly 20 is used. Those of ordinary skill in the art will understand that numerous other shaped enclosure assemblies may be used depending on the size constraints and the amount of dispersion needed for the light emitted from the LEDs 90.

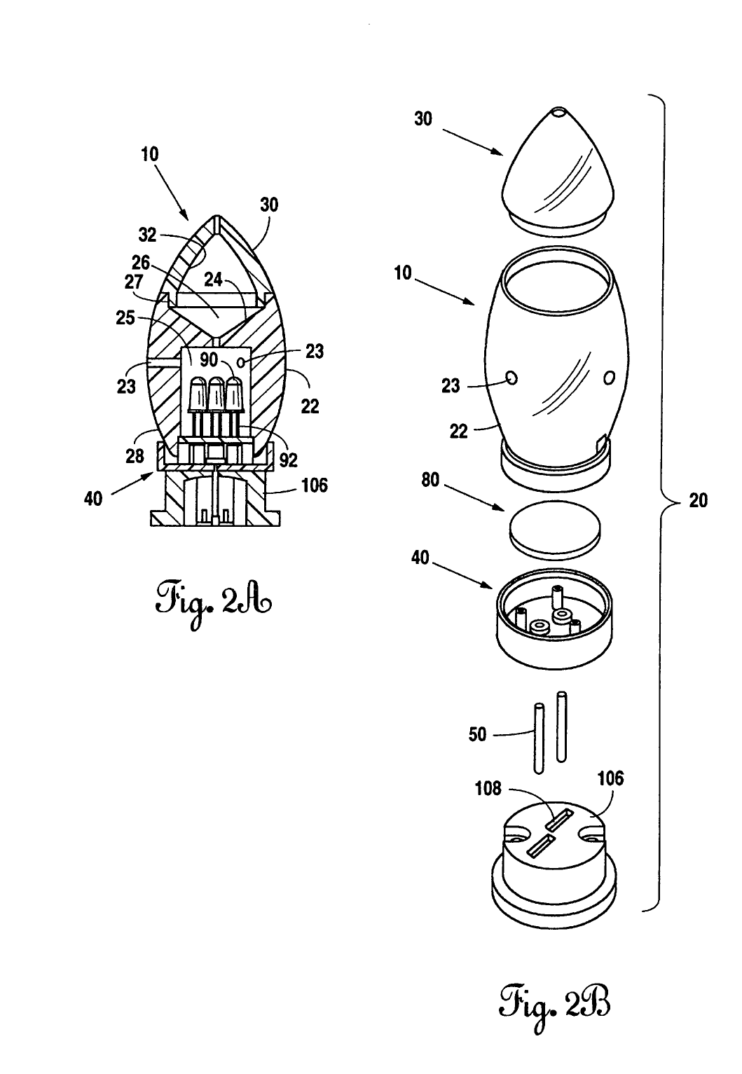

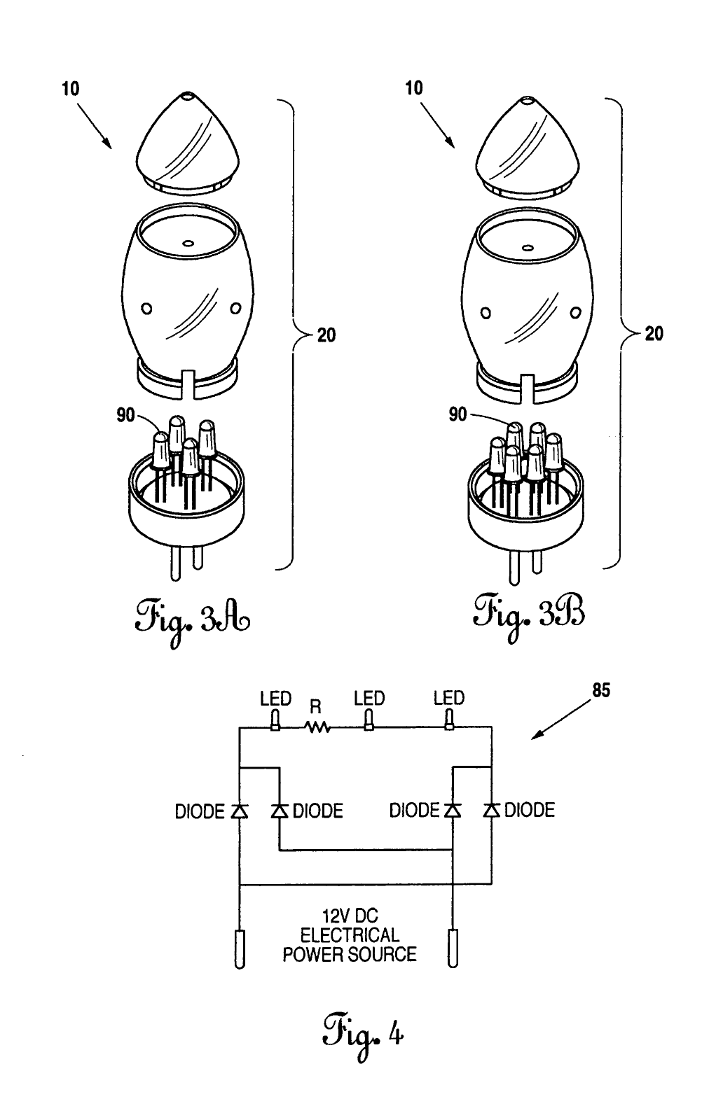

The construction of the LED bulb 10 of the present invention is best understood by reference to FIGS. 2A and 2B. As may be seen in FIG. 2A, the illustrated LED bulb 10 includes three LEDs 90. As shown in FIG. 3A and 3B others numbers of LEDs 90 may be used in the LED bulb 10 without departing from the scope of the invention. While it is expected that white or off-white LEDs 90 will be used in most applications, any color LED 90 or any combination of colored LEDs 90 may be used. The LEDs 90 are located in an opening 25 within the central hollow enclosure portion 22 of the enclosure assembly 20. The top portion 21 of the central portion 22 of the enclosure assembly 20 includes a concave opening 26. Fitting into a shouldered recess 27 at the top of the concave opening 26 is a hollow top portion 30. Surrounding the bottom 28 of the central portion 22 of the enclosure assembly 20 is a lower cover assembly 40 through which two terminal pins 50 extend.

The terminal pins 50 receive electrical energy when plugged into openings 108 in a socket 106. This electrical energy is conducted to an integrated circuit on a chip or wafer 80 sized to fit within the lower cover assembly 40. An example of the integrated circuit 85 included in the chip or wafer 80 appears in FIG. 4. The arrangement of the diodes and the resistor R assure that the terminal pins 50 can be put in either opening 108 in a two-holed socket 106 and electrical energy of the proper polarity will be supplied to the LEDs 90. As known to those of ordinary skill in the art LEDs are electrically polarized and will only illuminate when properly polarized electrical energy is supplied.

The bottom of the hollow top portion 30 of the bullet-shaped enclosure assembly 20 is shaped to fit within a shoulder recess 27. The space 25 within the enclosure assembly 20 of sufficient size to accommodate one or more LEDs 90. When illuminated, the emitted light from the LEDs 90 will reflect from the sides of the concave opening 26 and from the interior surface 32 of the hollow top portion 30. This reflection of emitted light will cause the central portion 22 and the top portion 30 of the enclosure assembly 20 to give the appearance of being filled with light.

Because LEDs 90 which are used for illumination purposes also emit a lot of heat, the central portion 22 of the bullet-shaped enclosure assembly 20 includes one or more vent holes 23 to promote the entry of ambient air into the space 25 within the bullet-shaped enclosure assembly 20. To provide additional cooling, the LEDs 90 are mounted so that they are elevated to a position near the midst of the opening 25 within the enclosure assembly 20. Such mounting exposes a portion of the leads 92 from the LEDs 90 to ambient air. This exposure of the a portion of the leads 92 to ambient air assists in conducting heat away from the LEDs 90.

Connecting the leads 92 from the LEDs 90 to a power source is a pair of terminal pins 50. The terminal pins 50 are connected to an electrical circuit 85 within the LED bulb 10 which permits electrical energy to flow only in only one direction to the one or more LEDs 90 within the LED bulb 10. Such circuits 85 are well known to those of ordinary skill in the art who use a polarized power source to provide electrical energy. The terminal pins 50 are the same size so that there is no need to identify the polarity of the LEDs 90, and the LED bulb 10 of the present invention may be placed in a socket 106 irrespective of the orientation of the terminal pins 50.

In FIG. 3 it may be seen that the light emitted by the LED 90 is dispersed by multiple reflective surfaces. The first reflective surface is within the LED 90 itself. The second reflective surface is the side walls 24 of the conical opening 26 formed in the top of the central portion 22 of the enclosure assembly 20. The third reflective surface 32 which reflects light from the individual LEDs 90 is the inside 32 of the conical opening within the hollow top portion 30 of the enclosure assembly 20.

Manufacture of the LED bulb of the present invention may be accomplished in a variety of ways; however, workable LED bulbs 10 have been produced using the following steps:

mounting the electrically polarized LEDs 90 to a miniaturized circuit 85 having terminal pins 50 extending therefrom. The circuit 85 assures that the LEDs 90 receive electrical energy in the needed polarity to properly illuminate;

placing the LEDs 90 and a wafer containing the circuit 85 in the lower cover assembly 40;

placing the central portion 22 of the enclosure assembly 20 including at least one reflective surface therein over the LEDs 90 such that central portion 22 of the enclosure assembly 20 engages the lower cover assembly 40;

placing the hollow top portion 30 including at least one reflective surface 32 therein on the central portion 22 of the enclosure assembly 20.

While the LED bulb 10 of the present invention has been described in terms of its preferred embodiment in what some might call a flame or bullet shaped enclosure assembly, those of ordinary skill in the art will understand that numerous other designs of enclosure assemblies may be used without departing from the disclosed invention. Such other systems may include cylinders with round or flat sides, spheres, cones, or the typical bulbous shape found in many incandescent light bulbs.

While the present invention has been disclosed according to a preferred embodiment, those of ordinary skill in the art will understand that other embodiments of the disclosed invention will be enabled by the foregoing disclosure. Such other embodiments shall be included within the scope and meaning of the appended claims.

What is claimed is:

1. An LED light bulb comprising:
one or more LEDs;
a mounting for said one or more LEDs, said mounting including:
a lower cover assembly constructed and arranged for positioning the leads to said set of LEDs so that heat may be dissipated from said leads to said set of LEDs;
a circuit allowing the light bulb to be connected to a polarized source of electrical power in either direction;
an enclosure for said set of LEDs,
a hollow enclosure including a space for said set of LEDs;
at least one reflective surface within said hollow enclosure for dispersing the light emitted by said one or more LEDs.

2. The LED light bulb as defined in claim 1 wherein said hollow enclosure is bullet shaped.

3. The LED light bulb as defined in claim 1 wherein said hollow enclosure includes a separable hollow top portion.

4. A socket mounted lighting system including one or more electrically polarized LEDs as a light source, said socket mounted lighting system comprising:
a mounting base, said mounting base including two electrical contacts for providing electrical energy to the electrically polarized LEDs irrespective of the orientation of the mounting base in the socket;
a vented enclosure constructed and arranged for interfitment with said mounting base, said vented enclosure including an opening for surrounding the one or more electrically polarized LEDs, said vented enclosure further including at least one surface for reflection of the light emitted by the one or more electrically polarized LEDs.

5. The socket mounted lighting system as defined in claim 4 wherein said vented enclosure is bullet shaped.

6. The socket mounting lighting system as defined in claim 4 wherein said vented enclosure includes a separable top portion.

7. A changeable bulb including at least one LED light source, said changeable bulb comprising:
a mounting base, said mounting base including contacts for conducting electrical energy to the at least one LED;
a circuit for receiving electrical energy from said contacts and transforming said electrical energy into a polarity usable by the at least one LED, said circuit being included within said mounting base;
a hollow enclosure constructed and arranged to be supported by said mounting base,
said hollow enclosure being further constructed and arranged to surround said at least one LED light source
at least one reflecting surface formed within said hollow enclosure for dispersing the light emitted by the at least one LED light source.

8. A garden lighting device, said garden lighting device comprising:
a plurality of sockets;
an electrical conductor for providing electrical energy to said plurality of sockets from a source of electrical energy;
a plurality of bulbs, each of said plurality of bulbs including at least one LED as a light source;
each of said plurality of bulbs including:
a mounting base, said mounting base including two electrical contacts for providing electrical energy to said at least one LED;
an enclosure constructed and arranged for interfitment with said mounting base, said enclosure including an opening for surrounding said one or more LEDs, said enclosure further including at least one surface for reflection of the light emitted by said one or more LEDs.

9. A method of manufacturing a light bulb including at least one or more electrically polarized LEDs, said method comprising the steps of:
mounting the electrically polarized LEDs in a base assembly, said base assembly having a pair of electrical connections;
including within said base assembly a circuit for providing electrical energy to the electrically polarized LEDs to cause them to illuminate;
surrounding the one or more electrically polarized LEDs in an enclosure, said enclosure being constructed and arranged to mount to said base assembly;
including one or more reflective surface within said enclosure for dispersing the light emitted by the one or more electrically polarized LEDs.

10. The method as defined in claim 9 wherein the at least one or more LEDs are mounted in the base assembly to expose a portion of the leads thereto to ambient air.
